(19) United States
(12) Patent Application Publication
(10) Pub. No.: US 2015/0096316 A1
(43) Pub. Date: Apr. 9, 2015

(54) AIR CONDITIONING SYSTEM FOR A MOTOR VEHICLE

(71) Applicants: Bodo Thiele, Langenfeld (DE); Rowena Tomski, Huckelhoven (DE)

(72) Inventors: Bodo Thiele, Langenfeld (DE); Rowena Tomski, Huckelhoven (DE)

(21) Appl. No.: 14/509,747

(22) Filed: Oct. 8, 2014

(30) Foreign Application Priority Data
Oct. 8, 2013 (DE) 10 2013 220 249.0

(51) Int. Cl. B60H 1/00; F25B 29/00

(52) U.S. Cl. CPC B60H 1/00007; F25B 29/003
USPC 62/115; 62/228.1

(57) ABSTRACT

An air conditioning system of a motor vehicle is provided herein, as well as a method for the same. The air condition system includes a refrigerant circuit including a compressor and an evaporator located inside the flow duct; an air conducting device provided downstream of the evaporator in the air flow direction; a heating heat exchanger provided inside the flow duct; and a control unit to receive a signal from a sensor. The control unit is configured to receive a position of the air conducting device from the position sensor, the control unit is configured to switch the compressor off or on based on the position.

### CROSS-REFERENCE TO RELATED APPLICATION

This U.S. Patent Application claims priority to German Patent Application No. DE 10 2013 220 249.0, filed October 8, 2013 entitled “Air Conditioning System for a Motor Vehicle,” the entire disclosure of the application being considered part of the disclosure of this application and hereby incorporated by reference.

### BACKGROUND

In a motor vehicle air conditioning system designed to condition an air mass flow that is fed into it, the passenger compartment must be supplied with an air mass flow that has been temperature controlled as requested. In this process, the infed air mass flow is conducted over various heat exchangers, so that the air is cooled and dehumidified, if necessary, reheated, before being conducted into the passenger compartment. The air is blown into the foot well, for example, and into the passenger compartment via openings in the dashboard, and may be conducted via outlet openings directly to the windshield for defogging or defrosting.

In a conventional air flow-controlled air conditioning systems, the air mass flow fed to the passenger compartment is cooled and/or dehumidified as it flows across the surfaces of a heat exchanger, after which, is divided by a damper into two partial air mass flows. The temperatures that are employed for the air flows are also adjusted with the aid of temperature doors having various control mechanisms. In this process, one partial air mass flow is conducted through a heating heat exchanger and is heated. At the same time, a second partial air mass flow flows past the heating heat exchanger as cold air. The two differently temperature-controlled partial air mass flows are then blended in order to achieve the target temperature.

The heat exchanger that is provided for cooling and dehumidifying the air mass flow is designed as an evaporator, which is a component of a refrigerant circuit. In addition to the evaporator, the refrigerant circuit comprises a condenser, an expansion device and a compressor.

The fuel consumption of the motor vehicle is determined in part by the compressor in the refrigerant circuit of the motor vehicle air conditioning system. The compressor is switched on and off on the basis of various conditions, such as maintaining an ambient temperature. The compressor may be switched on at ambient temperatures that are only slightly above freezing, or within a range of 0° C. to 5° C. At ambient temperatures that range up to approximately 20° C., the compressor may not be employed in order to achieve the desired comfort level inside the passenger compartment. When the ambient air is at these temperatures, the air to be fed into the passenger compartment is dehumidified only under certain conditions, in order to keep the windows from fogging.

When the compressor is operated by switching it on and off based on ambient conditions, the parameters frequently are not differentiated clearly enough. As a result, the compressor will continue to operate in situations where cooling or dehumidifying the air is not requested or wanted.

To decrease or to optimize fuel consumption, generic air conditioning systems with externally controlled compressors have been designed. Externally controlled compressors allow the target temperature at the evaporator to be variably controlled by a predetermined input. To condition the air inside the passenger compartment, the air is not cooled any further than is necessary for dehumidification, and is then reheated, resulting in a decrease in heating power during reheating of the air mass flow. A decrease in temperature beyond the cooling that is necessary for dehumidifying the air would require greater heating power for reheating the air mass flow, and therefore greater compressor power.

In a conventional motor vehicle air conditioning system, temperature control inside the passenger compartment can be adjusted by a temperature control adjuster, between a lower cooling temperature and an upper heating temperature by correspondingly cooling and heating the air mass flow to be conveyed into the passenger compartment. The cooling power of a refrigerator includes an evaporator and a compressor, and the heating power of a usable heat generator are varied by adjusting the temperature control adjuster. The cooling power is adjusted by adjusting the speed of the compressor drive.

Conventionally, a manually controllable air conditioning system in a motor vehicle is provided. The system includes an externally controlled refrigerant compressor, a condenser, an expansion device and an evaporator. A fan for fresh air and/or recirculated air is located upstream of the evaporator, which is arranged in an air conditioning system, and a heating heat exchanger with a temperature control valve assigned thereto is located downstream of said evaporator. The temperature control valve is actuated by a control element. The air temperature can be adjusted at the output side of the evaporator by adjusting the evaporation temperature within a predetermined temperature range by varying the operation of the refrigerant compressor. By selecting a discharge temperature within the predetermined temperature range using the control element, the power of the refrigerant compressor is adjusted and as a result, the evaporation temperature is adjusted.

The employment of these controlled compressors is highly costly and complex as compared with uncontrolled compressors.

However, when internally controlled or uncontrolled compressors are used, it is not possible to preset a target temperature at the evaporator. Nevertheless, since internally controlled or uncontrolled compressors are substantially less cost-effective than externally controlled compressors, they will continue to be used routinely in the future.

In another conventional implementation, an air temperature control device for use in motor vehicles is also provided that includes a cooler, a heater and an inside air temperature controller. With the air temperature control device, feedback control is achieved by comparing the inside air temperature as an actual temperature with the predetermined target temperature. The device comprises a controller for the cooler operating cycle, where the operating cycle is adjusted such that the inside air temperature controller will remain on as long as possible in a position for greatest cooling power or in an adjacent range or in a range for maximum cooling power.

### SUMMARY

An air conditioning system of a motor vehicle is provided herein, as well as a method for the same. The air condition system includes a refrigerant circuit including a compressor and an evaporator located inside the flow duct; an air conducting device provided downstream of the evaporator in the air flow direction; a heating heat exchanger provided inside the flow duct; and a control unit to receive a signal from a sensor. The control unit is configured to receive a position of the air conducting device from the position sensor, the control unit is configured to switch the compressor off or on based on the position.

### DESCRIPTION OF THE DRAWINGS

The detailed description refers to the following drawings, in which like numerals refer to like items, and in which:

FIG. 1 is an air conditioning system according to a conventional implementation; and

FIG. 2 is an illustration of an example system for controlling an air conditioning system according to an exemplary embodiment.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience

Disclosed herein is a motor vehicle air conditioning system for conditioning the air inside a passenger compartment of the motor vehicle. The air conditioning system may include a refrigerant circuit with an evaporator and a compressor. The aspects disclosed herein allow individual comfort for the passenger, and promotes an air conditioning system to have minimal energy consumption at the compressor, while enabling automatic conditioning of the air inside the passenger compartment.

The air conditioning system disclosed herein includes a housing that forms at least one flow duct for conducting air, a refrigerant circuit having a compressor and an evaporator arranged inside the flow duct. Additionally, an air conducting device located downstream of the evaporator in the air flow direction is provided. The air conducting device is designed to be seamlessly adjustable between two end positions. The range for adjusting the air conducting device between the two end positions is also referred to as the adjustment range.

Within the flow duct, a heating heat exchanger is arranged downstream of the air conducting device in the air flow direction. The air mass flow can be conducted over the heating heat exchanger via the air conducting device. The air conditioning system also includes a control unit, configured to receive signals from various sensors.

The control unit is connected to a position sensor for determining the position of the air conducting device, in order to ascertain, from the position of the air conducting device, the need for heating power or cooling power in the air mass flow fed to the passenger compartment. The control unit is also configured to switch the compressor of the refrigerant circuit off or on.

A position sensor determines the position of the air conducting device. Therefore, the position sensor does not need to be a separate component. Instead, in the case of an air conducting device driven by a stepper motor, for example, the position could also be determined from the number of steps in relation to the total number of steps between the end positions. In said case, the compressor is switched off when the air conducting device is located within a control range, and when at least one partial air mass flow is being conducted over the heat exchange surface of a heating heat exchanger. The compressor is switched on when the air conducting device has been moved to a “full cold” end position, and when no air mass flow is flowing over the heat exchange surface of the heating heat exchanger.

The air mass flow that has been cooled and/or dehumidified as it flows over the heat exchange surface of the evaporator is then divided by means of the air conducting device into partial air mass flows, and is conducted over a heat exchanger designed as a heating heat exchanger, or around the heating heat exchanger via a bypass.

The air conducting device may be designed as a blend air door. The blend air door may be pivotably mounted.

When the compressor is switched on or off based on the position of the air conducting device, the heating power to be transferred to the air mass flow after cooling and/or dehumidification is advantageously reduced.

The control unit may also be configured to close an air conducting device in response to the compressor being switched off (for example, at the moment the compressor is switched off), so that the air mass flow fed into the passenger compartment is blown into the passenger compartment for a predetermined time period that begins when the compressor is switched off, without being conducted directly to the windshield via outlet openings. The air conducting device is also designed to conduct at least part of the air mass flow to be fed into the passenger compartment to the windshield.

The compressor may be designed as an internally controlled or uncontrolled compressor, driven by the motor vehicle engine. Alternatively, the compressor can also be electrically driven.

The control unit may also be configured to receive signals from a sensor module of the motor vehicle engine in order to ascertain whether the motor vehicle engine is in a start-up phase or in the operating phase.

The method for operating the air conditioning system is also disclosed herein. The method employs a housing that forms at least one flow duct for conducting air, a refrigerant circuit having a compressor and an evaporator arranged inside the flow duct, an air conducting device located downstream of the evaporator in the air flow direction, and a heating heat exchanger, along with a control unit for receiving signals from various sensors, with the following operations:
determining the position of the air conducting device by a position sensor and transmitting a signal that contains the position to the control unit,
employing the control unit to determine, based on the position of the air conducting device, whether heating power or cooling power in the air mass flow is to be fed into the passenger compartment, and
switching the compressor of the refrigerant circuit off or on in order to supply refrigerant to the evaporator based on the need for heating power or cooling power.

In this method, the compressor is switched off when the air conducting device is located within a control range, and when at least one partial air mass flow is being conducted over the heat exchange surface of the heating heat exchanger. The compressor is switched on when the air conducting device has been moved to the “full cold” end position, and when no air mass flow is being conducted over the heat exchange surface of the heating heat exchanger. The compressor is therefore switched on when no warming or heating of the cooled and/or dehumidified air mass flow is actuated by means of the air conducting device.

Because in air conditioning systems that have an internally controlled or uncontrolled compressor in the refrigerant circuit, the target value of the temperature at the evaporator output is not adjustable. In contrast to externally controlled compressors, the compressor is selectively switched on and off based on the instantaneous state of the vehicle. In this process, existing variables and parameters that describe the system are considered.

According to one embodiment, in response to the compressor being switched off, an air conducting device is closed, so that the air mass flow to be fed into the passenger compartment is blown into the passenger compartment for a predetermined period of time without being conducted directly to the windshield via outlet openings. The air conducting device in this case is designed to conduct at least part of the air mass flow to be fed into the passenger compartment to the windshield. The predetermined period of time, which begins when the compressor is switched off, ranges from 30 seconds to 120 seconds, and one example is 60 seconds.

The power of a fan that conveys the air mass flow to be fed into the passenger compartment for the predetermined period of time, in order to maintain the comfort level inside the passenger compartment may be reduced.

According to another embodiment, the values for the ambient temperature, the evaporation temperature of the refrigerant in the evaporator, the temperature and the humidity of the air inside the passenger compartment, the position of an air conducting device for conducting recirculated air through the flow duct and/or the instantaneous operating mode of a fan for conveying an air mass flow through a flow duct are determined (or predetermined) and transmitted to the control unit.

That data about a motor vehicle engine, which drives the compressor of the refrigerant circuit, may be ascertained by a sensor module, and transmitted to the control unit. With the aid of the control unit, it is determined from the data about the motor vehicle engine whether the motor vehicle engine is in the start-up phase or in the operating phase.

The requirements for switching the compressor on may also depend on additional sensors. The compressor is switched on based on at least one of: the value of the ambient temperature, the value of the evaporation temperature of the refrigerant in the evaporator, the instantaneous operating mode of the fan for conveying an air mass flow through the flow duct, the position of an air conducting device for conducting recirculated air through the flow duct, the value of the temperature of the air in the passenger compartment, the value of the humidity of the air in the passenger compartment and/or the data about the motor vehicle engine.

A further aspect disclosed herein consists in that the determination of the position of the air conducting device is filtered, so that switching the compressor off or on follows the position of the air conducting device with a time lag, in order to avoid premature switching with rapid movements of the air conducting device.

The filtering of the position or the movement of the air conducting device therefore prevents a premature, fluctuating and frantic switching of the compressor on and off.

Based on the movement of the air conducting device, the compressor is switched on or off, and the power of the compressor is neither cycled over the short term nor decreased to a lower level.

Cycling in this case is understood as a rapid switching on and off of an uncontrolled compressor in order to operate the compressor for a longer period of time at a lower power. The refrigerant mass flow circulating in the refrigerant circuit and the cooling power at the evaporator are thereby reduced, and the air mass flow flowing over the evaporator is cooled less.

The time when the compressor is switched on is controlled based on various parameters. The parameters considered in this case are the filtered position of the air conducting device, the starting conditions of the motor vehicle engine, and the temperature of the ambient air and/or the humidity of the air inside the passenger compartment.

Employing the aspects described herein allows:
increasing the efficiency of the air conditioning system, because selectively switching the compressor on and off minimizes energy consumption or optimizes energy consumption for a desired level of comfort, and
transferring the advantages of externally controlled compressors to an air conditioning system that has a refrigerant circuit with an internal or uncontrolled compressor, without the additional costs of an air conditioning system that has an externally controlled compressor,
reflecting the behavior of the vehicle driver, for example, switching the air conditioning system off in dry weather on cold days, without any action by the vehicle driver,
simple adjustment of the air conditioning system and installation in the motor vehicle during production, for example, simple integration into existing control software, and
effective implementation of the control strategy during operation of the air conditioning system by the vehicle passengers.

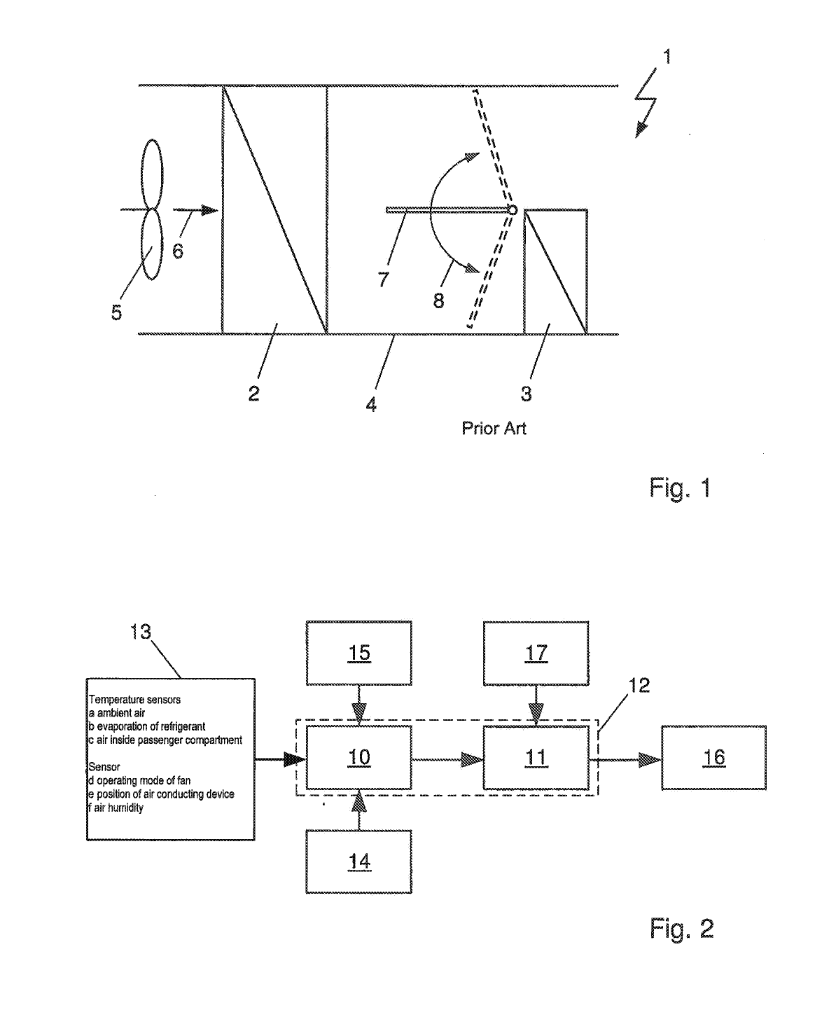

FIG. 1 illustrates an example air condition system according to a conventional implementation.

Referring to FIG. 1, an air conditioning system 1 has an air conducting device 7 designed as a temperature blend door, in various operating positions.

The air conditioning system 1 includes a fan 5 for drawing in and conveying the air in flow direction 6, an evaporator 2 and a heating heat exchanger 3, which are arranged inside a housing 4. The housing 4 is a flow duct which conducts the air mass flow to the evaporator 2, and is divided into two flow paths downstream of the evaporator 2 in air flow direction 6.

To condition the air inside the motor vehicle, ambient air is drawn in, for example. If the temperature of the ambient air is below approximately 20° C., the air mass flow will be heated, whereas if the temperature is above 20° C., the air mass flow will be cooled. In the latter case, the air mass flow that has been drawn in is conducted over the heat exchangers arranged in the air conditioning system 1, and is cooled and/or dehumidified as it flows over the heat exchange surface of the evaporator 2. The temperature blend door 7 allows a partial air mass flow can then be conducted over the additional heat exchangers designed as heating heat exchangers 3, in order to heat the air mass flow or a partial air mass flow of the air to be fed into the passenger compartment to a desired temperature, thereby conditioning the air inside the passenger compartment to a desired internal temperature.

By employing a controlled compressor within a refrigerant circuit, which also includes the evaporator 2, the air mass flow is cooled only to the temperature for dehumidification, and is then reheated by a smaller difference than if internally controlled or uncontrolled compressors are used. When internally controlled or uncontrolled compressors are used, the air mass flow is cooled much more. The decreased cooling of the air mass flow results in a savings of energy, in particular, a reduction in compressor power.

The air mass flow drawn in by the fan 5 is then conducted in its entirety over the heat exchange surface of the evaporator 2, after which it can be divided between the two flow paths. The first flow path conducts the air that has been cooled and/or dehumidified by the evaporator 2 as a partial air mass flow inside a bypass around the heating heat exchanger 3, which is located inside the second flow path. The partial air mass flow that is conducted through the second flow path is conducted in its entirety over the heat exchange surfaces of the heating heat exchanger 3 and is heated. The second flow path is therefore also referred to as the hot air path.

The two flow paths open into a blending chamber. The partial air mass flows that have been divided between the two flow paths are recombined and blended in the blending chamber, before the air that has been conditioned in this manner is fed into the passenger compartment via the individual air outlet openings, not shown.

The air conducting device 7 is a temperature blend door and is mounted so as to rotate about a rotational axis in rotational direction 8, the air mass flow that is conducted over the evaporator 2 is divided into the partial air mass flows in the flow paths. The partial air masses flowing through the flow paths, that is, the proportions of the total air mass flow being conducted through the air conditioning system 1, and therefore the temperature at the air outlets, can be controlled by adjusting the temperature blend door 7.

In a first end position, the temperature blend door 7 opens up the first flow path, while the second flow path is closed off. In this case, the entire air mass flow which was previously conducted through the evaporator 2 is conducted past the heating heat exchanger 3 as cold air. The first end position is also referred to as the “full cold” end position.

In a second end position, the temperature blend door 7 closes off the first flow path, while the second flow path is opened, so that the entire air mass flow which has been conducted over the heat exchange surfaces of the evaporator 2 is conducted over the heat exchange surfaces of the heating heat exchanger 3. As the air mass flow travels over the heat exchange surfaces of the heating heat exchanger 3, it is heated. No cold air is conducted around the heating heat exchanger 3. The second end position is also referred to as the “full hot” end position.

By rotating the temperature blend door 7 in rotational direction 8 about the rotating axis, the door is moved from the second “full hot” end position to the first “full cold” end position, and vice versa. In intermediate positions, the proportions of the total air mass flow are divided between the flow paths as partial air mass flows.

By partially opening up the flow paths in the blending chamber by placing the temperature blend door 7 in intermediate positions, the two partial air mass flows are throttled, in order to adjust a blending temperature of the air mass flow. Depending on the rotation and the positioning of the temperature blend door 7 in the direction of rotation 8, the flow paths are opened between 0% and 100% or are closed between 100% and 0%. The temperature blend door 7 is steplessly rotatable; therefore, the flow paths can also be steplessly closed and opened between 0% and 100%.

FIG. 2 illustrates a control system and method for the air condition system 1 illustrated in FIG. 1, according to exemplary embodiment disclosed herein. Referring to FIG. 2, the control system of the air conditioning system 1 is illustrated with a compressor 16.

The control system comprises a first control module 10 and a second control module 11, which is designed for controlling the compressor 16. The control modules 10 and 11 are arranged combined to form a control unit 12. The control unit 12 is configured to receive various signals for a range of parameters.

The first control module 10 is connected to a sensor module 13 of the air conditioning system 1. The sensor module 16 includes a plurality of sensors for ascertaining a range of sensed parameters. The sensors included may be one, some or all of the following: the values for the temperature of the ambient air, the evaporation temperature of the refrigerant in the evaporator 2, and the instantaneous operating mode of the fan 5 are determined and are transmitted from the sensor module 13 to the first control module 10. In addition, sensors that are connected to the sensor module 13 can be used to determine additional values, such as the position of the door for conducting recirculated air and/or ambient air to the fan 5, the temperature of the air in the passenger compartment and the air humidity, and these can likewise be transmitted from the sensor module 13 to the first control module 10.

Employing a control element 14 that can be operated by the passenger, the first control module 10 of the control unit 12 can likewise receive and process signals relating to target values for desired parameters and the resulting change in the values inside the passenger compartment.

The first control module 10 is also designed to receive signals from a position sensor 15 for determining the position of the air conducting device 7, in order to ascertain therefrom the need for heating power or cooling power in the air mass flow to be fed into the passenger compartment.

From the data received from the sensors of the sensor module 13 of the air conditioning system 1, the position sensor 15 of the air conducting device 7 and the control element 14 for the passenger, the first control module 10 identifies signals that are transmitted to the second control module 11 of the control unit 12. The second control module 11 is configured to control the compressor 16.

The control module 11 of the compressor 16 is configured to receive both the signals transmitted by the first control module 10 and signals from a sensor module 17 of the motor vehicle engine. In particular, the sensor module 17 of the motor vehicle engine transmits signals for the purpose of determining whether the motor vehicle engine is in the start-up phase (at the moment of starting) or is already in the operating phase.

The second control module 11 of the control unit 12 is connected to the compressor 16, and is configured to switch it off or on.

The compressor 16 remains switched off during the time when the air conducting device 7 is in a control range. The control range is the predominant partial range of the air conducting device 7 adjustment range between the “full cold” and “full hot” end positions. The air conducting device 7 is located within the control range when it is not in the first “full cold” end position, so that either a partial air mass flow or the entire air mass flow is being conducted over the heat exchange surface of the heating heat exchanger 3.

However, the compressor 16 can be switched on even when the air conducting device 7 is positioned close to the “full cold” end position, that is, the compressor 16 is switched on, for example, when the air conducting device 7 reaches the point just before the “full cold” end position, at less than approximately 2% referred to the entire adjustment range. However, the compressor 16 is not switched off until the air conducting device 7 has moved approximately 12%, referred to the entire adjustment range, beyond the “full cold” end position.

Only at the moment when the air conducting device 7 is no longer actuating any heating of the air mass flow, that is, when the air conducting device has been moved to the first “full cold” end position, is the compressor 16 is switched on. The requirements for switching the compressor 16 on can also be dependent on other parameters, as needed, for example, air humidity. If it is necessary to dehumidify warm air, which will also be cooled thereby, the compressor 16 is switched on even if the air conducting device 7 is not located in the “full cold” end position.

At the moment when the compressor 16 is switched off, that is, when the air conditioning system 1 is in the state in which there is no longer any need for cooling power in the air mass flow to be fed to the passenger compartment, and the air humidity is at non-critical levels for fogging the windows, the air to be fed to the passenger compartment is blown for a predetermined period of time directly into the passenger compartment, for example, into the foot well and through openings in the dashboard, and is not conducted directly to the windshield through outlet openings in order to keep the windshield fog-free. Within this period of time, the power of the fan 5 is also reduced in order to maintain the necessary level of comfort inside the passenger compartment. The predetermined period of time ranges from 30 seconds to 120 seconds, and is preferably 60 seconds.

In this case, the outlet openings for conducting the air mass flow to the windshield by means of an air conducting device, also referred to as defrost doors, are closed. At the time when the compressor 16 is switched off, the surface of the evaporator 2 is wetted with water that is condensed out of the air during dehumidification, which can be picked up and/or carried along as the air mass flow flows over said surface, and can be deposited as fog on the windshield. Within the predetermined time period of 30 seconds to 120 seconds, this humid air mass flow is diverted from the windshield.

The compressor 16 is switched on or off based on the position of the air conducting device 7, which does not correspond to short-term cyclical operation or to a reduction in compressor power, but to a switching of the compressor 16 on or off. To avoid triggering premature switching with rapid movements of the air conducting device 7, the movement of the air conducting device 7 is also filtered. The switching point of the actual position of the air conducting device 7 therefore has a time lag. The time when the compressor 16 is switched on, that is, the time when the compressor 16 is switched back on, is controlled on the basis of parameters. As a result, a premature, fluctuating and frantic switching of the compressor 16 on and off is avoided.

Switching the compressor 16 off at the moment when the air conducting device 7 reaches the point just before the “full cold” end position, at less than approximately 2% referred to the entire adjustment range, or switching the compressor 16 on when the air conducting device 7 is located approximately 12% in front of the “full cold” end position, for example, referred to the entire adjustment range, is not carried out at the instantaneous actual positions of the air conducting device 7 in each case. The positions of the air conducting device 7 as an indication of the adjustment range are calculated values that have a time lag.

Significant movement spikes or deflections of the air conducting device 7 resulting from an aggressive or spontaneous temperature control are thereby reduced, and as a result, premature switching processes at the compressor 16 are avoided. For example, the air conducting device 7 is located in a position that corresponds to 25% of the adjustment range, and it is set to a temperature of 25° C. of the air mass flow to be fed into the passenger compartment. A sensor for determining the intensity of solar irradiation simultaneously ascertains a high value, resulting in a new target temperature of 18° C. Without the calculated values that result from the substantial difference in target temperature, advantageously with a time lag, the air conducting device 7 would be moved toward the “full cold” end position and might remain in the “full cold” end position for a period of up to 10 seconds. The compressor 16 would therefore be switched on for this period of time. To avoid this unnecessary switching-on process, the movement of the air conducting device 7 is filtered, and therefore, the position of the air conducting device 7 is on a time lag as a result of a filter.

The essential switching parameters include the filtered position of the air conducting device 7, the moment when the compressor 16 is switched on, the starting conditions, and the temperature of the ambient air. If necessary, the humidity of the air inside the passenger compartment is also taken into consideration.

1. An air conditioning system of a motor vehicle, comprising a refrigerant circuit including a compressor and an evaporator located inside the flow duct;
an air conducting device provided downstream of the evaporator in the air flow direction;
a heating heat exchanger provided inside the flow duct; and
a control unit, to receive a signal from a sensor, wherein,
the control unit receives a position of the air conducting device from the position sensor,
the control unit is configured to switch the compressor off or on, wherein”:
the compressor is switched off in response to the air conducting device being
within a control range, and a partial air mass flow is over the heating heat exchanger, and
the compressor is switched on in response to the air conducting device being in a an end position with no air mass flow over the heating heat exchanger.

2. The system according to claim 1, wherein the control unit is configured to close an air conducting device in response to the compressor being switched off, thereby preventing an air flow from being conducted directly to the windshield via an outlet opening.

3. The system according to claim 1, wherein the control unit is configured to receive a signal from a sensor module of the motor vehicle engine in order to ascertain whether the motor vehicle engine is in the start-up phase or in the operating phase.

4. A method for operating an air conditioning system, comprising:
determining a position of an air conducting device via a position sensor;
determining whether heating power or cooling is fed into a passenger compartment based on the position; and
switching a compressor of a refrigerant circuit off in response to the position being within a predetermined control range and some air flow being conducted over a heat exchange a heating heat exchanger of the air conditioning system, and
switching the compressor on in response to no air flow being conducted over the heating heat exchanger.

5. The method according to claim 4, further comprising closing the air conducting device in response to the compressor being switched off so that the air flow is directed to a passenger compartment and not to a windshield of the motor vehicle.

6. The method according to claim 4, further comprising:
determining at least one of the:
the value for the ambient temperature;
the value for the evaporation temperature of the refrigerant in the evaporator; the
instantaneous operating mode of a fan for conveying an air mass flow through a flow duct;
the position of an air conducting device for conducting ambient air through the flow duct;
the value for the air temperature in the passenger compartment;
the value for the humidity of the air inside the passenger compartment; and
transmitting one of the above determinations to control the air condition system.

7. The method according to any of claim 4, further comprising:
determining data about a motor vehicle engine by means of a sensor module, transmitting the data to the control unit; and
ascertaining, whether a motor vehicle engine is in the start-up phase or in the operating phase.

8. The method according to claim 4 further comprising filtering the position sensing to determine whether premature switching based on rapid movements of the air conducting device.
